(19) United States
(12) Patent Application Publication
(10) Pub. No.: US 2009/0159719 A1
(43) Pub. Date: Jun. 25, 2009

(54) CONTROL METHOD OF A DEVICE FOR NEBULIZING LIQUIDS INTO THE AIR

(75) Inventor: Jean-Claude Millet, Etoile Sur Rhone (FR)

Correspondence Address: SEED INTELLECTUAL PROPERTY LAW GROUP PLLC, 701 FIFTH AVE, SUITE 5400, SEATTLE, WA, 98104, US

(73) Assignee: OSMOOZE, Loriol Sur Drome (FR)

(21) Appl. No.: 12/336,281

(22) Filed: Dec. 16, 2008

(30) Foreign Application Priority Data
Dec. 17, 2007 (FR) 07 08773

(51) Int. Cl. B05B 17/04

(52) U.S. Cl. 239/11; 239/70; 239/69

(57) ABSTRACT

A control method for one or several devices for nebulizing liquids into the air (DF1), the method including control steps for the device to nebulize a liquid into the air according to nebulizing cycles during which a liquid is nebulized into the air, the nebulizing cycles being spaced by idle periods, and comprising adjustment of the duration of idle periods as a function of the average quantity of liquid to be nebulized per unit time selected, and as a function of a concentration parameter for the active product in the liquid to be nebulized. The method enables a same apparatus to treat volumes with a factor of 100 times, typically from 7 to 700 m³.

### BACKGROUND

1. Technical Field

This disclosure concerns devices for nebulizing liquids into the air, for purposes of humidification or cooling of the air, or notably for spraying, cleaning, deodorizing, and disinfecting products, or perfumes.

2. Description of the Related Art

Some liquid nebulization devices include a housing for receiving an aerosol canister of the liquid to be sprayed, and a mechanism for periodically triggering release of the product in the form of an aerosol for a fixed duration. To release a liquid in the form of an aerosol, the mechanism includes an actuator to open the valve by pressing on the nozzle of the canister. Devices of this type are sold under the trademarks Microburst 3000® and Microburst 9000®. These devices device can only treat volumes within a limited size range, from 40 m³ to about 170 m³, and also have a relatively limited operating life depending on the size of the aerosol canister, which can reach 6 months for the smallest volumes and 1.5 months for the largest volumes.

Another type of liquid nebulization device is for example described in U.S. Patent Application Publication No. US2007/262163, which is incorporated by reference herein in its entirety. This device includes a capillary tube with one end forming a liquid ejection nozzle, a feed reservoir connected to the capillary tube by a pipe, a vibrating member to vibrate the capillary tube so that it ejects droplets of liquid into an nebulizing jet, and driving means for applying a driving signal to the vibrating mechanism.

The U.S. Pat. No. 6,712,287, which is incorporated by reference herein in its entirety, plans programming a device for nebulizing liquids into the air in such a way as to produce a perception of an “odor peak” in users. Such a perception is obtained when the perfume is sprayed periodically in a certain quantity during nebulization cycles separated by idle periods. The duration of the idle cycles is calculated by taking into consideration the olfactory neurosensory characteristics of individuals. Furthermore it is possible to provide a waiting time likely to allow desire to develop in the user, so as to reinforce his pleasure at the moment when the odor peak arrives.

This method of odor peak nebulization proves to be optimum in terms of efficiency (overall olfactory perception compared to the quantity of perfume sprayed) over a period of several minutes to several hours. On the other hand, continuous nebulization gives poor efficiency. In fact, because of the human neurosensory characteristics and particularly the phenomenon of habituation, the perception of an odor diminishes and disappears after a few minutes, unless the odor is of excessive intensity and therefore induces nausea that may be intolerable.

To avoid this habituation phenomenon, some devices are programmed to change the type of perfume that is sprayed from time to time.

There are also devices controlled by a computer according to a program for example in association with multimedia data. Other devices are programmed to produce a welcoming odor in a temporarily occupied location. For this purpose, they are coupled to presence detection so that the welcome odor is sprayed when someone is detected.

Generally speaking, the above-mentioned devices do not enable to reach the best olfactory yield for all possible combinations of parameters associated with olfactory efficiency, and especially the olfactory atmosphere to be created (welcome, permanent atmosphere, odor peak), and with the characteristics of the treated location (volume, function). Nor do they allow programming spraying cycles at will depending on other criteria, including by allowing to shift from optimal olfactory efficiency, especially if the products sprayed are not perfumed.

Besides, the above-mentioned devices are suitable for treating a limited range of volumes. In fact, to treat smaller volumes, the duration of the idle periods between perfume nebulizing cycles can be increased, but this risks affecting the stability of olfactory perception, especially when spraying a welcome odor in a location that is occupied on a temporary basis. The duration of perfume nebulizing cycles and therefore the quantity of perfume sprayed can be reduced, but this option has limits. The olfactory sensation of a perfume depends on its concentration in the surrounding air. Moreover, the olfactory rendering is not directly proportional to the quantity of perfume present in the air. Below a certain threshold, there is no perception. Beyond this threshold, perception increases in a non-linear and variable fashion from one perfume to another. Besides, when the duration of the nebulizing cycles is less than a certain value of the order of 50 ms, it is difficult to control the flow rate of liquid thus sprayed.

On the other hand, to treat larger volumes, the duration of idle periods can be reduced, but this affects the operating life of the device with respect to its supply of liquid to be sprayed and its power supply if it is powered by a limited energy source, for example by electric batteries. The duration of each nebulizing cycle can also be increased, which also affects the consumption by the device of liquid to be nebulized and its electricity consumption. Moreover, for functional reasons (especially thermal losses from the actuator(s) which can introduce operating drifts), it is better not to increase the duration of liquid nebulizing cycles beyond a few seconds. Besides, it may be observed that, if the quantity of liquid nebulized by a device exceeds about 12 g per day, drops of nebulized liquid can be deposited around the device. This phenomenon is produced with liquids having a low content of light or volatile solvents, i.e. whose flash point is below 62° C. in order to comply with environmental and safety restrictions.

Finally, none of the above-mentioned devices enables the real needs of users to be met, nor can they be adapted to the place where the device is used. In fact, their mode of operation cannot really be adapted to the tastes and olfactory sensitivity of all users. Nor in particular can their mode of operation be adapted to the size and function of the room, nor to the ventilation conditions, or to the precise location of the device in the room. In particular, the above-mentioned devices equally do not enable treatment of volumes smaller than 20 m³ or greater than 300 m³. Moreover, the devices that can treat up to 300 m³ cannot be adapted to volumes less than 75 m³, and the devices suitable for volumes up to 30 m³ cannot be used to treat volumes exceeding 120 m³.

### BRIEF SUMMARY

It is therefore desirable to provide a device for nebulizing a perfume that is versatile in order to be able to create an ambient odor or odor peaks in rooms from 15 to 360 m³, or an olfactory bubble 1 to 10 m in diameter.

It is also desirable to achieve this result using a single device with the least possible number of modifications.

In the context of professional use, it is also desirable that the device has an operating life as long as possible in terms of power supply and liquid to be nebulized, for economic reasons and to limit maintenance operations for the device. For this latter reason, it is also desirable for the operating lives in terms of electricity and nebulized liquid to be consistent, and in particular, for the battery life to be a multiple of that of the liquid cartridges.

According to an embodiment, a control method is provided for controlling a device for nebulizing liquid into the air, the method comprising steps of: controlling the device for nebulizing a liquid into the air according to nebulizing cycles during which a liquid is nebulized into the air, the nebulizing cycles being spaced by idle periods, and adjusting the duration of the idle periods according to an average quantity of liquid to be nebulized per unit of time selected. According to an embodiment, the method comprises a step of adjusting the duration of idle periods as a function of a concentration value of the active product in the liquid to be nebulized.

According to an embodiment, the method comprises adjusting the duration of the nebulizing cycles or the quantity of liquid to be nebulized in each nebulizing cycle as a function of an average quantity of liquid to be nebulized per unit time selected and on the concentration value for the active product contained in the liquid to be nebulized.

According to an embodiment, the duration of each nebulizing cycle is adjusted to a value between one hundred milliseconds and a few seconds, and the duration of each idle period between the nebulizing cycles is adjusted to a value between several tens of seconds and a few minutes.

According to an embodiment, adjusting the duration of the idle periods as a function of the concentration of active product in the liquid contained in the cartridge can be performed when the concentration of active product has a value between 2.5% and 15%, and preferably between 2.5% and 60%.

According to an embodiment, the method includes a step of capturing the concentration value by reading information contained in an electronic label attached to the removable cartridge supplying the device with liquid to be nebulized.

According to an embodiment, the method includes step of adjusting the duration of nebulizing cycles depending on the ambient temperature provided by a temperature sensor.

According to an embodiment, the method includes step of adjusting the duration of the idle periods and/or nebulizing cycles depending on information provided by a sensor.

According to an embodiment, the respective durations of successive idle periods are adjusted in such a way as to produce “odor peaks”, taking account of human olfactory neurosensory characteristics and by providing an additional waiting time.

According to an embodiment, the concentration of active product in the liquid to be nebulized is selected according to the volume to be treated by the device and so that the operating life of the batteries supplying the device should be an integer multiple at least equal to 1 times the life of the removable cartridge supplying the device with the liquid to be nebulized.

According to an embodiment, the method includes a step of switching from a waiting phase to an active phase following the detection of the presence of a user by a sensor, triggering the reduction of the idle periods, and a return step to the waiting phase after a certain time following the detection of the user's departure by the sensor, triggering the restoration of the duration of the idle periods programmed for the waiting phase.

According to an embodiment, the method includes a configuration step for the operating mode of the device consisting of determining the duration of idle periods and nebulizing cycles or the quantity of liquid to be nebulized in each nebulizing cycle depending on at least one parameter belonging to the group including the dimensions and a function of the room where the device is installed, the number of devices installed in the room, the position of the device in the room in relation to the openings and ventilation ducts, the spray mode for the liquid to be nebulized, the electrical consumption of the device, and the consumption by the device of the liquid to be nebulized.

According to an embodiment, the method includes the transmission of operating parameters to a plurality of devices for nebulizing liquids into the air.

According to another embodiment, a device for nebulizing liquids into the air is provided, comprising: a nebulization circuit, a removable cartridge containing a liquid to be nebulized linked to the nebulization circuit, and a control unit for controlling the nebulization circuit in order to nebulize the liquid into the air according to nebulizing cycles during which a liquid is nebulized into the air, the nebulizing cycles being spaced by idle periods, the control unit being configured to adjust the duration of the idle periods as a function of the average quantity of liquid to be nebulized per unit time selected, and as a function of a concentration value of active product in the liquid to be nebulized.

According to an embodiment, the control unit is configured to adjust the duration of nebulizing cycles depending on the average quantity of liquid to be nebulized selected and on the concentration value for active product contained in the liquid to be nebulized.

According to an embodiment, the control unit is configured to set the duration of each nebulizing cycle to a value between one hundred milliseconds and a few seconds, and the duration of each idle period between the nebulizing cycles is adjusted to a value between several tens of seconds and a few minutes.

According to an embodiment, the control unit is configured to be able to adjust the duration of the idle periods as a function of the concentration of the active product in the liquid contained in the cartridge when the concentration of the active product has a value between 2.5% and 15%, and preferably a value between 2.5% and 60%.

According to an embodiment, the device includes a reading unit for reading an electronic label attached to the cartridge, connected to the control unit, the control unit being configured to capture from the reading unit the concentration parameter for liquid contained in the cartridge, stored in the electronic label.

According to an embodiment, the control unit is configured to adjust the duration of nebulizing cycles according to the ambient temperature provided by a temperature sensor connected to the control unit.

According to an embodiment, the control unit is configured to adjust the duration of idle periods and/or nebulizing cycles according to information provided by a sensor connected to the control unit.

According to an embodiment, the control unit is configured to determine the respective durations of successive idle periods in such a way as to produce “odor peaks”, taking account of human olfactory neurosensory characteristics and by providing an additional waiting time.

According to an embodiment, the control unit is configured to trigger reduction of the duration of idle periods to a value set for an active phase following detection of the presence of a user by a sensor, triggering restoration of the duration of idle periods st for a waiting phase after a certain time following the detection of the user's departure by the sensor.

According to an embodiment, the device includes a transmission device connected to the control unit, in order to receive operating parameters from a remote control device, the control unit being configured to determine the duration of idle periods and/or duration of nebulizing cycles according to the parameters received.

According to an embodiment, the parameters received from the control device by the control unit include the dimensions and a function of the room where the device is installed, as well as a spray mode for the liquid to be nebulized.

According to an embodiment, the control unit is configured to transmit information on the condition of the device to the remote control device.

According to an embodiment, the transmission device is connected to the remote control device through a wireless or cabled connection.

According to an embodiment, the device is configured to forward a message originating from the remote control device and intended for another device, and forward a message received from another device and intended for the remote control device.

According to another embodiment, a system for nebulizing liquids into the air is provided, comprising several devices for the nebulization of liquids into the air. According to an embodiment, the devices match that described above.

According to an embodiment, each of the devices is configured to forward a message originating from the remote control device and intended for another one among the devices, and forward a message received from another among the devices and intended for the remote control device.

### BRIEF DESCRIPTION OF THE SEVERAL VIEWS OF THE DRAWINGS

Some embodiments of the present invention will be described in the following, this disclosure not being limiting, in relation with the attached figures, among which:

FIG. 1 represents the liquid nebulization device of the vibrating capillary tube type,

FIG. 2 is a diagrammatic view of a first embodiment of a nebulization device,

FIG. 3 is a diagrammatic view of a second embodiment of a nebulization device,

FIG. 4 is a diagrammatic view of an installation including several pieces of a nebulization device.

### DETAILED DESCRIPTION

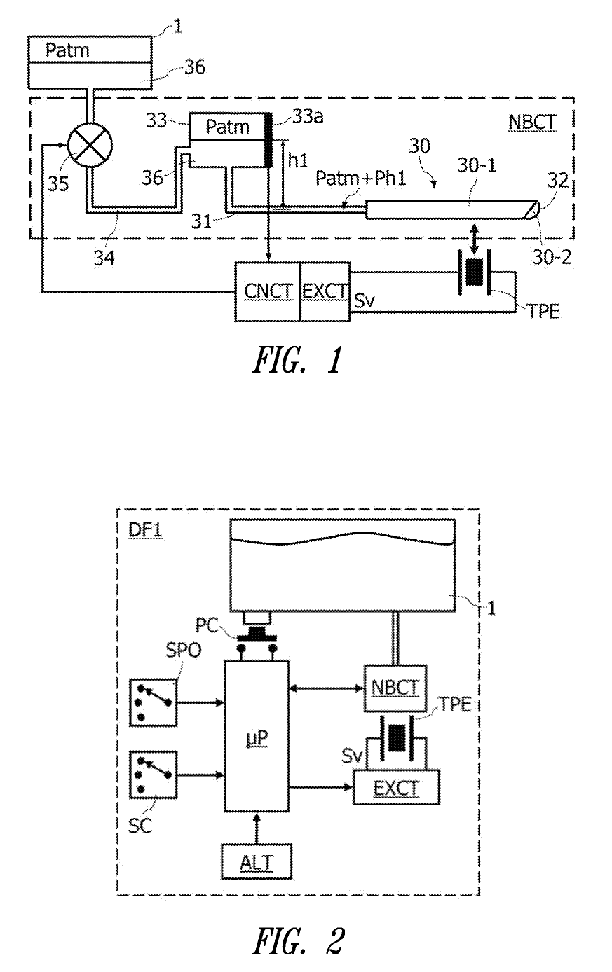

FIG. 1 represents a general diagram of a liquid nebulization device of the type having a vibrating capillary tube. The device includes a principal reservoir 1 containing a liquid 36 to be nebulized, and a nebulization circuit NBCT fed by the reservoir 1. The nebulization circuit NBCT includes a nebulization head 30, an intermediate reservoir 33 also containing liquid 36, a pipe 31 connecting the reservoir 33 to the nebulization head 30 and a pipe 34 equipped with an electric pump or valve 35, connecting reservoir 1 to reservoir 33. Reservoirs 1 and 33 are under atmospheric pressure Patm. The nebulization head 30, substantially horizontal, includes a capillary tube 30-1 and a nozzle 30-2 for liquid ejection. The nebulization head generally takes the form of a hollow needle with internal diameter less than one millimeter and a length of a few centimeters, the body of which forms the capillary tube 30-1 and the distal end of which, beveled, forms the ejection nozzle 30-2. The nebulization head 30 is mechanically coupled to a vibrating mechanism, generally a resonating piezo-electric transducer TPE. The TPE transducer is driven by an alternating signal Sv supplied by a circuit DRVR. The circuit DRVR is controlled by a control circuit CTRL that defines the duration of nebulizing cycles during which the nozzle 30-2 releases nebulized liquid, and the duration of idle periods between the nebulizing cycles. The circuit CTRL also controls pump 35 and adjusts the level of liquid in the intermediate reservoir 33, which is monitored by means of a level detector 33a.

When the driving signal Sv is applied to the TPE transducer, the nebulization head begins to resonate and droplets 32 of liquid 36 are ejected, forming a sort of mist of droplets or “nebulization jet”. During the nebulization, the nebulization head 30 is fed with liquid by capillary effect and by gravity, pressure at the inlet to the capillary tube 30-1 being a function of height h1 of the column of liquid between the intermediate reservoir 33 and the capillary tube 30-1.

FIG. 2 represents a second embodiment of a nebulizing device. In FIG. 2, the nebulizing device DF1 includes a main reservoir 1 comprising for example a removable cartridge, a nebulization circuit NBCT such as was presented in FIG. 1, fed with liquid to be nebulized by cartridge 1, a piezo-electric transducer TPE mechanically coupled to a nebulization head of circuit NBCT, a driver DRVR supplying an alternating driving signal Sv to the TPE transducer, and a control circuit including a microprocessor μP controlling the nebulization circuit NBCT and the driver DRVR. Microprocessor μP is fed by a power circuit ALT and is connected to a presence contact PC on cartridge 1, and to a selector SPO for selecting the average quantity of liquid to be nebulized per time unit. In the case of a perfume, this quantity is equivalent to an olfactory power. Selector SPO enables for example selecting a value for the idle period from three values such as 30 s, 60 s and 120 s. If the nebulizing cycle time is 300 ms and the concentration of active product in the liquid to be nebulized is 5 or 6%, the device can treat volumes of the order of 300 m³, 150 m³ and 75 m³, with idle periods of respectively 30 s, 60 s and 120 s.

According to an embodiment, the nebulizing device includes a concentration selector SC connected to the microprocessor μP and enabling indicating to the latter the concentration of active product, for example a perfume, in the liquid contained in the cartridge. The concentration selector SC includes for example three or four positions, in order to select the concentration of active product contained in cartridge 1. Concentration information may be found for example on the cartridge. The selector for average quantity of liquid to be nebulized per time unit SPO can also include three positions in order to make a selection from three olfactory powers. The microprocessor μP is programmed in order to adjust automatically the duration of the nebulizing cycles of the liquid contained in the cartridge and the duration of the idle periods between nebulizing cycles as a function of the positions indicated by the two selectors SC and SPO. If the selector SC includes four positions and selector SPO three positions, the microprocessor μP can thus adapt the nebulization to the treatment of twelve different volumes.

The concentration of active product in the liquid to be nebulized contained in the cartridge 1 can vary between 2.5% and 10%. In fact, to meet the requirements of certain standards and cost constraints, the concentration can hardly ever exceed 10%, this being double or triple the concentration of perfume in liquids currently sold for spraying. However, if it is accepted that for certain applications or certain products to be sprayed other standards may apply, the concentration can be increased, for example, up to 60%. The concentration of active product can also hardly ever be less than 2.5%, in order to guarantee that the threshold of olfactory perception is exceeded with average durations of nebulizing cycles and idle periods between cycles.

Of course, each nebulizing cycle can comprise micro-cycles of nebulization spaced by short idle periods having a duration of the order of the nebulization micro-cycles.

The following table gives some examples of volumes treated and of cartridge life durations for different values of active product concentration in the nebulized liquid, and durations of nebulizing cycles and idle periods:

TABLE 1

| | | | Quantity | | |
|---|---|---|---|---|---|
| Concen- | Atom. cycle | Idle period | of liquid | Volume | Cartridge |
| tration | duration | duration | nebulized | treated | life |
| (%) | (ms) | (s) | (mg/day) | (m³) | (days) |
| 3 | 250 | 300 | 775.19 | 13.95 | 399.90 |
| 6 | 100 | 120 | 775.19 | 27.91 | 399.90 |
| 10 | 300 | 120 | 2325.58 | 139.53 | 133.3 |
| 15 | 300 | 120 | 2325.58 | 209.30 | 133.3 |
| 15 | 300 | 60 | 4651.16 | 418.60 | 66.65 |
| 10 | 100 | 240 | 387.60 | 23.26 | 799.80 |

The values in Table 1 were obtained for a nebulized liquid flow rate of 0.0108 mg/ms, a quantity of active product nebulized per unit volume of 1.67 mg/m³ and a quantity of liquid in the cartridge of 310 g. A minimum volume of less than 15 m³ can thus be treated with a cartridge having an operating life greater than one year. Besides, a volume greater than 400 m³ can also be treated with the same device, with a cartridge having an operating life greater than 2 months. The last example given in Table 1 shows that a choice can be made to reduce the olfactory stability by markedly increasing the duration of idle periods, to favor limiting electrical consumption of the device or limiting consumption of the liquid to be nebulized by the device.

The option to respond to an additional parameter, that is the concentration of the liquid to be nebulized, offers an additional flexibility for configuring the device, enabling in particular, in the case where the device is powered by electric batteries, adjusting the electrical consumption of the device so that the operating life of the electric batteries is an integer multiple at least equal to 1 of the life of the cartridge. This provision enables limiting the maintenance operations.

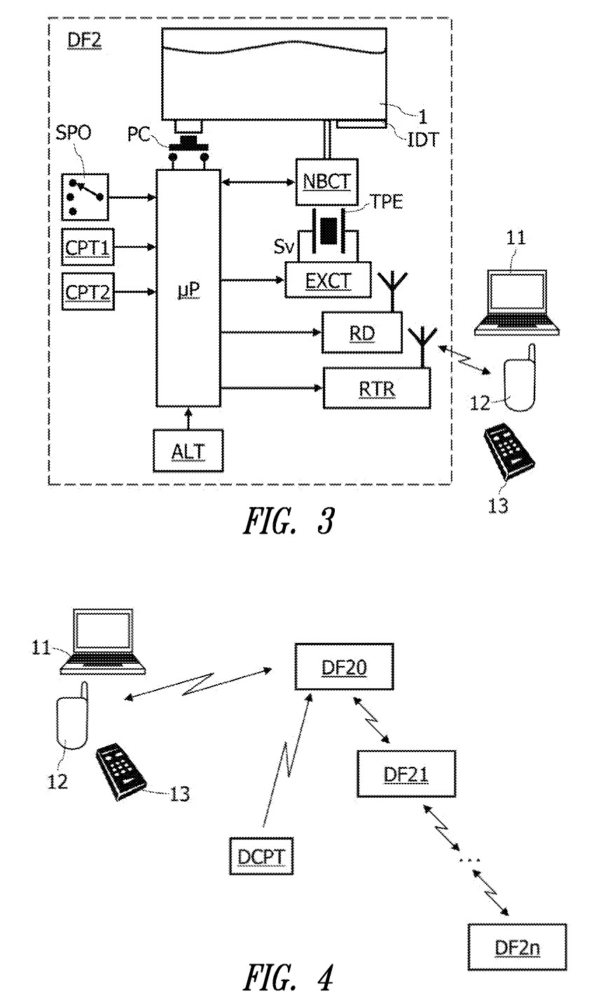

FIG. 3 represents another embodiment of a nebulization device. In FIG. 3, the nebulization device DF2 differs from device DF1 in that it does not have a concentration selector SC, but a reading device RD connected to the microprocessor μP, for reading an electronic label IDT, for example of RFID type, attached on the cartridge 1. Information on concentration of the liquid in cartridge 1 is stored in label IDT and read by the RD device that supplies this information to the microprocessor μP.

The device DF2 can also include one or several sensors CPT1, CPT2, connected to the microprocessor μP. The sensors CPT1, CPT2 comprise, for example, a presence sensor CPT1 to detect the presence of one or several users.

The microprocessor μP can thus also be programmed to spray perfume into individual toilets. For this purpose, the microprocessor is programmed in order to carry out a waiting phase during which it periodically performs a perfume nebulizing cycle, for example every 3 minutes, in order to maintain a welcome odor. Following the detection of the presence of a user, the microprocessor switches to an active phase during which it carries out a nebulizing cycle every 5 to 10 seconds. Following the detection of the user's departure, the microprocessor remains in the active phase for a certain time, for example 2 minutes, before returning to the waiting phase.

For use of the device in public places such as public toilets, the microprocessor can be programmed to adapt by itself the duration of nebulizing cycles and the duration of idle periods between nebulizing cycles, depending on how frequently the place is used. In fact it's not economic to spray the same quantity of bacteriostatic product in a place irrespective of the place frequency of use. The sensor CPT1 connected to the microprocessor can then provide information relating to the use frequency of the place where the device DF2 is installed, for example the number of people coming in.

According to an embodiment, the sensors CPT1, CPT2, include a temperature sensor CPT2. It turns out that the flow rate of liquid to be nebulized varies depending on the ambient temperature. The microprocessor can thus be programmed in order to maintain the quantity of liquid nebulized in each nebulizing cycle approximately constant by taking into account the ambient temperature supplied by sensor CPT2.

According to an embodiment, the device includes a wireless transmission device RTR enabling remote configuration of operation for device DF2 from a distant control device (dedicated remote control 13, computer 11 or “Smartphone” type mobile phone 12). The transmission device RTR includes for example a Bluetooth or Wi-Fi type wireless communication interface, or a cabled communication interface, for example of Ethernet or type USB, or by carrier current. The RTR device can also be configured in order to send, for example to the computer 11, information relating to the condition of the device DF2.

According to a simplified embodiment, remote configuration is reduced to setting the olfactory power parameter that was introduced by the selector SPO in the embodiment shown in FIG. 2.

According to an embodiment, remote configuration enables the user equipped with a remote control device 11, 12 or 13 to introduce information such as the dimensions or volume of the room where the device DF2 is installed, the function of the room (reception hall, meeting room, toilets, lounge . . . ), the position of the device in relation to openings or ventilation ducts, and a spray mode for the liquid to be nebulized such as for example “odor peak” and “welcome odor”. An application installed in the remote control device 11, 12 or 13, determines as a function of the information introduced by the user and the concentration of liquid in the cartridge, the durations of the nebulizing cycles and the durations of idle periods and sends this information to device DF2. The calculated durations can be determined for values or ranges of values supplied by the sensors CPT1, CPT2. Alternatively, the application can determine a quantity of liquid to be nebulized for each nebulizing cycle, the duration of the nebulizing cycle being adjusted by the microprocessor μP according to the temperature supplied by the sensor CPT2 and the quantity of liquid to be nebulized received by the application. If the volume to be treated is greater than the treatment capacity of the device or if the quantity of liquid to be nebulized must be greater (for example greater than the threshold for deposition of drops around the device), several devices can be installed in the same volume. In this case, the application determines the nebulization parameters (duration of the idle periods and of the nebulizing cycles or quantity of liquid to be nebulized for each cycle) for each device installed in the volume taking into account the presence of other devices.

Of course, all or some of the treatments performed by an application installed in the remote control device 11, 12 or 13 can be carried out by microprocessor μP. Equally, the concentration parameter for the liquid contained in the cartridge 1 can be provided by the user through the control device 11, 12 or 13. In this case, it is not necessary for the device to be fitted with a reading device RD and for the cartridge 1 to carry an electronic label.

According to an embodiment illustrated in FIG. 4, several nebulization devices DF20, DF21 . . . DF2n of DF2 type communicate with one another through the transmission device RTR fitted to each device. One of these devices, for example DF20, is considered as the master device and forwards orders coming from the remote control device (computer 11, mobile phone 12, dedicated remote control 13) intended for the other devices DF21 . . . DF2n. In general, each device forwards the orders that are not intended for it to the other devices. Conversely, each device forwards to the control device information on the operating condition received from the other devices. For this purpose, each message sent by one of the devices or the remote control device includes an identifier enabling each of the devices or the control device to determine if the message is intended for it or not.

These provisions enable in particular to minimize the transmitting power required in the case of wireless transmissions, and therefore also the electrical consumption of the devices. These provisions also enable minimization of the programming and supervision times for the devices when a large number of devices are to be installed in the same space or even building, such as for example in an office block.

The remote control device 11, 12 or 13 can also receive information from remote sensors DCPT, for example a detector or counter of people. Thus, as each of the devices DF20-DF2n operates as a transmission relay, it's not necessary for the transmission device RTR equipping each device to have a great range.

It will be obvious for those skilled in the art that the present invention can have different variants in both implementation and applications. In particular, the present invention is not limited to an adjustment in the duration of nebulizing cycles and the duration of idle periods between nebulizing cycles, simultaneously. The concentration of the active product in the liquid to be nebulized is only limited to 15% because of standards and labeling and cost constraints. Consequently, no technical obstacle prevents the nebulization of a liquid containing more that 15% of active product.

1. A method of controlling a device for nebulizing liquid into the air, the method comprising steps of:
controlling the device for nebulizing a liquid into the air according to nebulizing cycles during which a liquid is nebulized into the air, the nebulizing cycles being spaced by idle periods,
adjusting the duration of idle periods as a function of a selected average quantity of liquid to be nebulized per unit of time, and
adjusting the duration of the idle periods as a function of a concentration value of an active product in the liquid to be nebulized.

2. The method according to claim 1, further comprising adjusting the duration of the nebulizing cycles or the quantity of liquid to be nebulized in each nebulizing cycle as a function of the selected average quantity of liquid to be nebulized per time unit and the concentration value of the active product contained in the liquid to be nebulized.

3. The method according to claim 1, further comprising adjusting the duration of each nebulizing cycle to a value between one hundred milliseconds and a few seconds, and the duration of each idle period between the nebulizing cycles to a value between several tens of seconds and a few minutes.

4. The method according to claim 1, wherein adjusting the duration of idle periods as a function of the concentration of active product in the liquid contained in the cartridge as a function of the concentration of active product, which has a value between 2.5% and 15% and preferably between 2.5% and 60%.

5. The method according to claim 1, further comprising capturing the concentration value by reading information contained in an electronic label attached to a removable cartridge supplying the device with liquid to be nebulized.

6. The method according to claim 1, further comprising adjusting the duration of the nebulizing cycles as a function of the ambient temperature provided by a temperature sensor.

7. The method according to claim 1, further comprising adjusting the duration of the idle periods and/or the nebulizing cycles as a function of information provided by a sensor.

8. The method according to claim 1, wherein further comprising adjusting the respective durations of successive idle periods to produce “odor peaks”, taking into account the human olfactory neurosensory characteristics and by providing an additional waiting time.

9. The method according to claim 1, wherein the concentration of active product in the liquid to be nebulized is selected as a function of the volume to be treated by the device and so that the operating life of electric batteries powering the device should be an integer multiple at least equal to 1 of the operating life of the removable cartridge supplying the device with liquid to be nebulized.

10. The method according to claim 1, further comprising triggering reduction of the idle periods to a value set for an active phase, following the detection of the presence of a user by a sensor, and triggering restoration of the duration of idle periods set for a waiting phase after a certain time following detection of the user's departure by the sensor.

11. The method according to claim 1, further comprising configuring an operating mode of the device, the configuring including determining the duration of the idle periods and nebulizing cycles or the quantity of liquid to be nebulized in each nebulizing cycle as a function of at least one parameter belonging to the group including dimensions and a function of a room where the device is installed, how many devices are installed in the room, a position of the device in the room in relation to openings and ventilation ducts, a spray mode for the liquid to be nebulized, an electrical consumption of the device, and consumption by the device of the liquid to be nebulized.

12. The method according to claim 1, further comprising transmitting operating parameters to several devices for liquid nebulization into the air.

13. A device for nebulizing liquids into the air, comprising:
a nebulization circuit,
a removable cartridge containing a liquid to be nebulized connected to an nebulization circuit, and
a control unit for controlling the nebulization circuit, for nebulizing the liquid into the air according to nebulizing cycles during which a liquid is nebulized into the air, the nebulizing cycles being spaced by idle periods, the control unit being configured to adjust the duration of the idle periods as a function of the average quantity of liquid to be nebulized per time unit selected, and as a function of a concentration value for an active product in the liquid to be nebulized.

14. The device according to claim 13, wherein the control unit is configured to adjust the duration of the nebulizing cycles as a function of a selected average quantity of liquid to be nebulized and the concentration value of the active product in the liquid to be nebulized.

15. The device according to claim 13, wherein the control unit is configured to adjust the duration of each nebulizing cycle to a value between one hundred milliseconds and a few seconds, and the duration of each idle period between to a value between several tens of seconds and a few minutes.

16. The device according to claim 13, wherein the control unit is configured to be able to adjust the duration of the idle periods as a function of the concentration of the active product in the liquid contained in the cartridge when the concentration of the active product has a value between 2.5% and 15%.

17. The device according to claim 13, further comprising a reading unit for reading an electronic label attached to the cartridge, connected to the control unit, the control unit being configured to capture from the reading unit the concentration value of the liquid contained in the cartridge, stored in the electronic label.

18. The device according to claim 13, wherein the control unit is configured to adjust the duration of the nebulizing cycles according to an ambient temperature provided by a temperature sensor connected to the control unit.

19. The device according to claim 13, wherein the control unit is configured in order to adjust the duration of the idle periods and/or the nebulizing cycles according to the ambient temperature provided by a temperature sensor connected to the control unit.

20. The device according to claim 13, wherein the control unit is configured to adjust the respective durations of successive idle periods in such a way as to produce “odor peaks”, taking into account the human olfactory neurosensory characteristics and by providing an additional waiting time.

21. The device according to claim 13, wherein the control unit is configured to trigger reduction of the idle periods to a value set for an active phase, following the detection of the presence of a user by a sensor, and triggering restoration of the duration of the idle periods set for a waiting phase after a certain time following the detection of the user's departure by the sensor.

22. The device according to claim 13, further comprising a transmission device connected to the control unit, for receiving from a remote control device operating parameters, the control unit being configured to determine the duration of the idle periods and/or the nebulizing cycles as a function of the parameters received.

23. The device according to claim 22, wherein the parameters received from the remote control device by the control unit include dimensions and a function of a room where the device is installed, as well as a spray mode for the liquid to be released.

24. The device according to claim 22, wherein the control unit is configured to transmit information on condition of the device to the remote control device.

25. The device according to claim 22, wherein the transmission device is connected to the remote control device though a wireless or cabled link.

26. Device according to claim 22, configured to forward a message originating from the remote control device and intended for another device, and forward a message received from another device and intended for the remote control device.

27. A system for nebulizing liquids into the air, comprising:
plural devices for nebulizing liquids into the air, each device Including:
a nebulization circuit,
a removable cartridge containing a liquid to be nebulized connected to an nebulization circuit,
a control unit for controlling the nebulization circuit, for nebulizing the liquid into the air according to nebulizing cycles during which a liquid is nebulized into the air, the nebulizing cycles being spaced by idle periods, the control unit being configured to adjust the duration of the idle periods as a function of the average quantity of liquid to be nebulized per time unit selected, and as a function of a concentration value for active product in the liquid to be nebulized, and
a transmission device connected to the control unit, and configured to receive from a remote control unit operating parameters, the control unit being configured to determine the duration of the idle periods and/or the nebulizing cycles as a function of the parameters received.

28. The system according to claim 27, wherein each of the devices is configured to forward a message originating from the remote control device and intended for another device, and to forward a message received from another device and intended for the remote control device.
